(19) United States
(12) Patent Application Publication
(10) Pub. No.: US 2010/0094627 A1
(43) Pub. Date: Apr. 15, 2010

(54) AUTOMATIC IDENTIFICATION OF TAGS FOR USER GENERATED CONTENT

(75) Inventors: Ravi Reddy Katpelly, Durham, NC (US); Kunal Kandekar, Morrisville, NC (US)

Correspondence Address: WITHROW & TERRANOVA CT, 100 REGENCY FOREST DRIVE , SUITE 160, CARY, NC, 27518, US

(73) Assignees: Concert Technology Corporation, Durham, NC (US); KOTA ENTERPRISES, LLC, WILMINGTON, DE (US)

(21) Appl. No.: 12/251,835

(22) Filed: Oct. 15, 2008

(51) Int. Cl. G10L 15/26; G06F 17/30

(52) U.S. Cl. 704/235; 707/E17.046

(57) ABSTRACT

A method and system for automatically identifying tags for a media item. An audio track associated with a media item is analyzed. References to individuals in the audio track are compared to known acquaintances of a user. Matches are identified as potential tags. Duplicate matches can be presented to the user for resolution.

### FIELD OF THE INVENTION

The present invention relates to tagging media items, and in particular relates to automatically identifying tags for a media item.

### BACKGROUND

It is increasingly common for an individual to share digital content with acquaintances. In the context of social networking, the content may relate to an event that has occurred in the individual's life, such as a photograph or a video of an activity in which the individual was involved. Such content is frequently ‘tagged’ with textual descriptors which relate to the content. Tags can be used for many different purposes. Visual content, such as photos or videos, are frequently tagged to provide information to those viewing the content, such as the location of the content, the individuals depicted in the content, or the activity taking place in the content.

Typically, content is generated or otherwise obtained, and the individual then applies one or more tags to the content. Frequently, individuals desire to include the names of acquaintances, such as their friends or colleagues, that appear in the content in a tag. After the individual publishes, or otherwise makes the content available for viewing, the individual may want to notify the acquaintances appearing in the content that the content is available for viewing. The individual will frequently generate an email containing a link to the newly published content and send the email to their acquaintances. Such sharing and viewing of content among acquaintances has proven very popular.

For certain content, such as a video, if a period of time has elapsed between the date the video was generated and the date the video will be tagged, it may be relatively difficult to recall the names of individuals appearing in the video. It may be necessary to review the video prior to tagging in order to determine who was depicted in the video. If the video is long, or if the video is just one of many videos that are being tagged and published, this may be a time-consuming process. Thus, there is a need for a mechanism to automatically identify individuals depicted in a media item for purposes of tagging the media item.

### SUMMARY OF THE INVENTION

The present invention identifies acquaintances that are associated with a media item, and can generate a tag identifying the acquaintances. According to one embodiment of the present invention, a user provides a tagging module with one or more contacts identifying the user's acquaintances. The contacts can comprise a list, such as an electronic address book, an instant message (IM) or Chat address book, or the like. The tagging module then loads and stores the contact information. This process can be a one-time process that is updated each time the user's contacts are updated with an additional acquaintance.

After the contact loading process finishes, the user may decide to share a video with their acquaintances. The user provides the video to the tagging module, which extracts an audio track associated with the video and converts the audio track from speech to text. The tagging module then analyzes the text and compares the text to the stored contact information. Upon matching text to a contact, the tagging module can select the text, or the contact, as a tag. Alternately, the tagging module may request the user to confirm that the video should be tagged with certain names or acquaintances.

The tagging module may determine that certain text matches more than one acquaintance. For example, the tagging module may find the name ‘John’ in the text, and may determine that the contact information includes a ‘John Anderson’ and a ‘John Ashcroft.’ The tagging module can provide this information to the user and request that the user identify which of the two acquaintances should be used to tag the video.

The tagging module can generate an email containing a link to the content and send the email to the acquaintances identified in the tags. The email addresses can be obtained at the time the tagging module processes the user's list of acquaintances, or the tagging module may be associated with a service, such as a social networking site that maintains user information and associated email addresses. The social networking site can determine that the acquaintances identified in the video are the same as certain members of the social networking site and obtain their email addresses.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block diagram of a system in which the present invention can be practiced according to one embodiment of the present invention;

FIG. 2 is a flow chart illustrating a process for automatically identifying tags according to one embodiment of the present invention;

FIG. 3 is a dialog box suitable for receiving confirmation from a user regarding tags according to another embodiment of the present invention; and

FIG. 4 is a block representation of a computer suitable for implementing aspects of the present invention according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

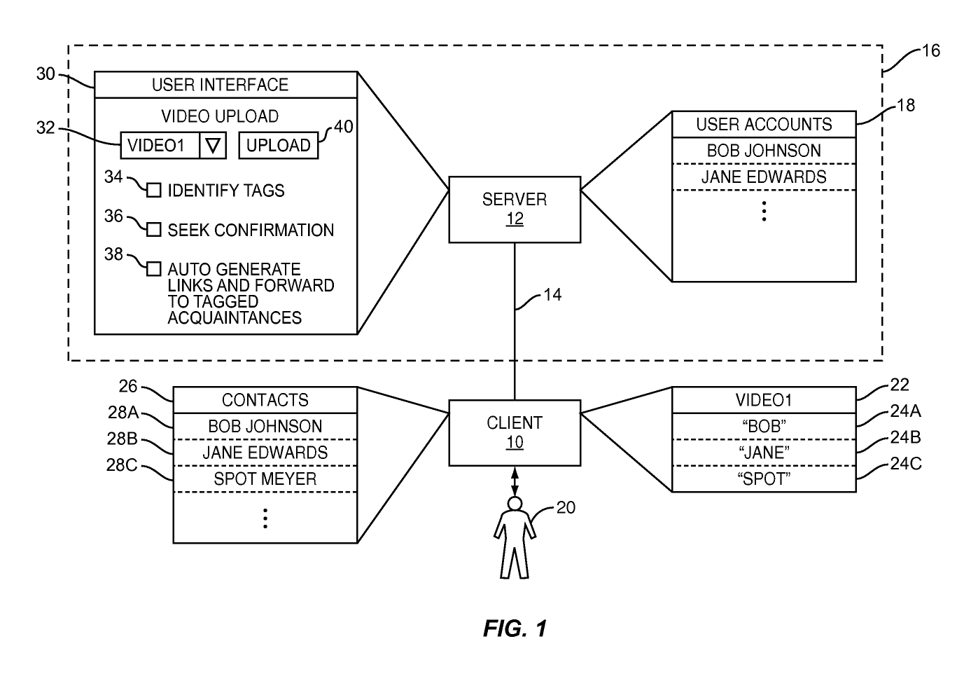

The present invention relates to automatically indentifying tags associated with a media item that a user desires to share with acquaintances or other individuals or entities. The present invention greatly simplifies the process for determining how to tag a media item with useful information, and eliminates having to play the media item to determine the individuals depicted or otherwise referenced in the media item prior to tagging the media item. FIG. 1 is a block diagram of a system in which the present invention can be practiced according to a client-server embodiment of the present invention. A client 10 is in communication with a server 12 via a network 14. The client 10 and server 12 can comprise any suitable processing devices suitable for implementing the functionality described herein. Preferably, the present invention is implemented in a software language such as C, C++, or any other suitable computer language capable of implementing the functionality described herein. However, some or all of the functionality described herein may be implemented in application-specific integrated circuits (ASICs) or in firmware, depending on the particular device or devices on which the present invention is being implemented. The network 14 can comprise any suitable network technology or combination of technologies, including wired and wireless, and messaging protocols, such as Transmission Control Protocol/Internet Protocol (TCP/IP).

The server may be associated with a website 16, such as a social networking website, which has a plurality of members identified by a user account 18. Preferably a user 20 of the client 10 is a member of the website 16. The user 20 desires to share a media item 22 with all or some of the members of the website 16. The media item 22 can comprise any suitable recording containing an audio track, such as an encoded voice recording or video recording. For purposes of illustration, it will be assumed the media item 22 comprises a video recording. The audio track associated with the media item 22 contains spoken references to a number of acquaintances of the user 20 that were recorded during the filming of the video. The references can include names 24A, 24B, and 24C of individuals who were depicted in the video. It is common for individuals to ‘tag’ a media item with textual information describing the media item. While tags are free format and can comprise any desired text, media items, such as the media item 22, are typically tagged with textual information describing some aspect of the media item 22. In the case of a video, the user 20 may desire to tag the media item 22 with the names of individuals referenced in the media item 22. If the media item 22 is a long video, is one of many videos the user 20 desires to tag, or is an old video, the user 20 may not recall which of their acquaintances were depicted in the video. Therefore, it may therefore be necessary for the user 20 to play the media item 22 prior to tagging in order to recall who is depicted in the media item 22. This process can be time-consuming and undesirable. The present invention, as described herein, eliminates the need to review the media item 22 and automatically identifies acquaintances that may be depicted in the media item 22 and, if desired, automatically tags the media item 22 with a tag identifying such acquaintances.

The user 20 may have a contact list 26 containing a plurality of contacts 28A, 28B, and 28C stored on the client 10 or elsewhere, such as on the server 12. Alternately, the contact list 26 can be obtained from other clients 10 or servers 12 via the network 14. The contacts 28A, 28B, and 28C can comprise references to individuals that the user 20 communicates with, such as names or user identifiers of such individuals. The contact list 26 can be an email address book, an instant message (IM) or Chat address book, or any other list or information repository suitable to identify acquaintances or other contacts of the user 20. According to one embodiment of the present invention, the user 20 provides the contact list 26 to the server 12. The server 12 can store the contact list 26 on a storage device (not shown). The user 20 may subsequently decide to share the media item 22 via the website 16. A user interface 30 can be displayed on the client 10 through conventional techniques for sending and displaying a web page over a network. Such techniques can include encoding the user interface 30 in a HyperText Markup Language (HTML) page, sending the HTML page from the server 12 to the client 10, and displaying the HTML page on a display (not shown) associated with the client 10 via a conventional web browser. The user interface 30 can include a media item identification field 32 where the user 20 can identify a pathname of the media item 22 to indicate to the server 12 the location of the media item 22 on a local storage device of the client 10. The user interface 30 may also include additional fields, such as an identify tags checkbox 34, which can be selected to direct the server 12 to implement the present invention and identify tags associated with the media item 22. The user 20 may select a seek confirmation checkbox 36 to indicate to the server 12 to request confirmation of the user 20 prior to actually tagging the media item 22 with any identified tags. A link generation checkbox 38 can be selected to indicate to the server 12 that messages, such as an email, containing a link, such as a Uniform Resource Locator (URL) or other reference, to the media item 22 should be sent to any members of the website 16 that are identified in a tag associated with the media item 22.

After entering the pathname of the media item 22 in the media item identification field 32 and selecting the desired checkbox fields 34, 36, or 38, the user 20 can select an upload button 40 to initiate the upload of the media item 22 to the server 12. The server 12 obtains the media item 22 from the client 10. The server 12 extracts an audio track associated with the media item 22 from the media item 22. Techniques for extracting audio information from a video are known to those skilled in the art, and will not be discussed herein. According to one embodiment of the invention, the audio track is converted from speech to text using conventional speech-to-text processing algorithms. According to another embodiment of the invention, a social dictionary is constructed that contains only social contact names. The social dictionary is used during the speech-to-text process. Because the social dictionary is a subset of the potential words in the speech, only the social contacts identified in the social dictionary are resolved, and all other words are filtered out. While the generation of a social dictionary adds a step to the overall process, it can be a one-time process that is updated when new social contacts are made, and may significantly reduce the memory and central processing utilization otherwise associated with the speech-to-text process.

According to one embodiment of the present invention, the words making up the text stream are then analyzed to determine if they are common and well known words that are not generally used as names. For example, an electronic database containing such words could be searched and, if the words match an entry in the database, the words can be discarded, which reduces the size of the text stream. The remaining words are more likely to be names than the discarded words. This step may be omitted if desired, or if the text stream was generated through the use of a social dictionary, as described above. In either case, the text stream is then parsed and each word in the text stream can be compared to the contact list 26. If a word matches a contact 28A, 28B, and 28C, the word and the respective contact 28A, 28B, and 28C can be stored for later presentation to the user for confirmation, if desired or appropriate. If the word matches more than one respective contact 28A, 28B, and 28C, then the word and all contacts 28A, 28B, and 28C that match the word may be stored for later presentation to the user 20 so the user 20 may identify the appropriate contact 28A, 28B, and 28C that is referenced in the media item 22.

After the text stream is completely processed, and assuming that the seek confirmation checkbox 36 was selected by the user 20, a list of names or contacts can be presented to the user 20 in a format that enables the user 20 to approve, reject, alter the name of the contact, or otherwise provide confirmation prior to tagging the media item 22 with the name or contact. Upon confirmation by the user 20, the server 12 can tag the media item 22. The choice of the exact text used to tag the media item 22 can be determined by the user 20 or the system, as desired by the operator of the website 16. For example, assume that the server 12 determines that the name 24A, ‘Bob,’ matches the contact 28A, ‘Bob Johnson.’ The user 20 may prefer that the text ‘Bob’ be used as the tag or, alternately, may prefer that the text ‘Bob Johnson’ be used as the tag. According to another embodiment of the present invention, the server 12 enables the user 20 to associate a predetermined tag with a contact 28A, 28B, and 28C, so that the predetermined tag is used to tag the media item 22 upon a match between a name 24A, 24B, and 24C and a contact 28A, 28B, and 28C. For example, the user 20 may informally know contact 28A as ‘Bobby,’ and indicate that the predetermined tag to use for contact 28A is ‘Bobby.’ According to one embodiment of the invention, a predetermined tag can comprise a URL or other reference to a webpage comprising, for example, a social networking page associated with the respective content. In yet another embodiment of the invention, the predetermined tag can comprise a clickable tag, such as a hyper media object.

The server 12 can then make the media item 22 available to other members of the website 16. The server 12 can also determine whether any of the contacts 28A, 28B, and 28C that have been identified in tags of the media item 22 are also members of the website 16. If so, the server 12 can generate a link, such as a URL or other reference, to the media item 22 and forward the link to the member via, for example, an email, an IM message, or other posting or distribution method known to those skilled in the art. If any of the contacts 28A, 28B, and 28C are not members of the website 16, the server 12 can ask the user 20 to provide email or IM addresses associated with the contacts 28A, 28B, and 28C.

While the identification of tags associated with the media item 22 has been described herein in conjunction with the server 12, the present invention can also be executed solely on the client 10. The present invention may be embodied in a program executing on the client 10 and may be activated by the user 20 prior to uploading the media item 22 to the server 12, so that the media item 22 already contains the appropriate tags prior to providing the media item 22 to the server 12. Alternately, the present invention may be embodied in a proxy that is in communication with the client 10 and the server 12. The proxy may receive the media item 22 and the contact list 26 from the client 10, or may have suitable authentication information for the server 12 to obtain the contact list 26 from the server 12. The proxy can identify the contacts 28 and can allow the user 20 to confirm, reject, or modify the identified contacts 28. The proxy can then tag the media item 22 with the appropriate contacts 28, and provide the media item 22 to the server 12. The proxy may comprise a service that is purchased by the user 20.

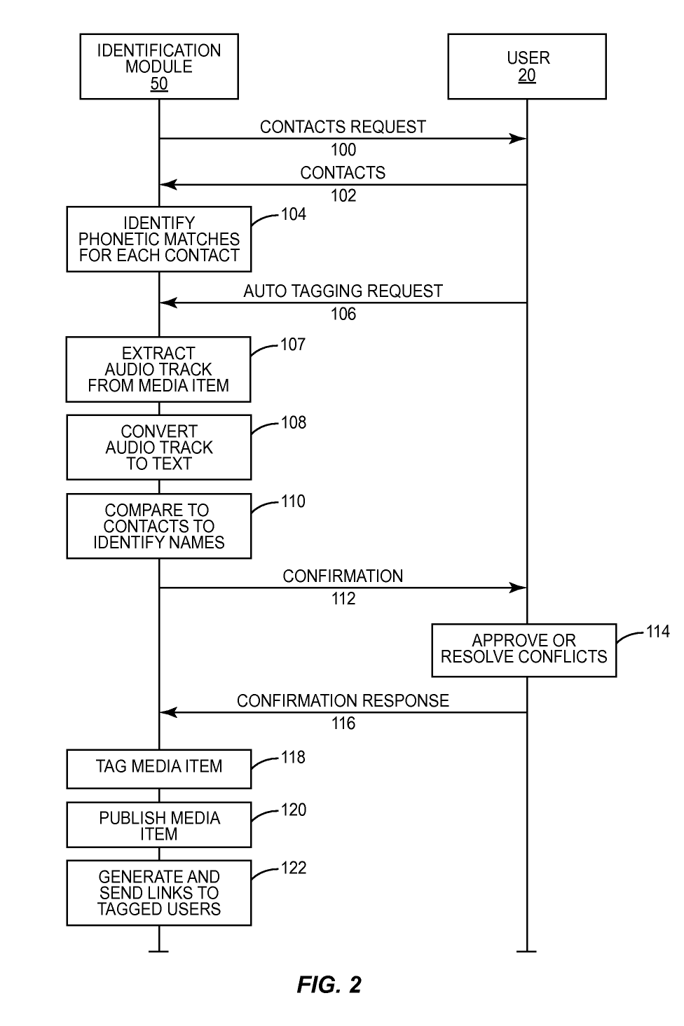

FIG. 2 is a flow chart illustrating a process for automatically identifying tags according to one embodiment of the present invention. An identification module 50 requests a list of contacts from the user 20 (step 100). In response, a contact list 26 is provided by the user 20 (step 102). According to one embodiment of the present invention, each contact 28 in the contact list 26 is processed through a phonetic algorithm, such as a Metaphone or Double Metaphone algorithm, to generate phonetic codes from the names of the contacts 28 (step 104). Nicknames associated with each contact 28 can also be determined. For example, if the name of a contact 28 is ‘Robert,’ nicknames such as ‘Bob,’ ‘Bobby,’ ‘Rob,’ and ‘Robby’ can be stored in association with the contact 28. Nicknames can be provided manually by the user 12, obtained from the server 12, obtained from a collaborative database populated by user annotations, or the like. Preferably, obtaining contacts and generating phonetic codes and nicknames is a one-time process. The user 20 requests automatic tagging and provides a media item 22 to the identification module 50 (step 106). The identification module 50 extracts an audio track from the media item 22 (step 107). Preferably, the audio track is converted from speech to text (step 108).

According to one embodiment of the present invention, common words can be discarded from the stream of text, leaving only those words that are likely to be names, or references, to individuals. The remaining words are processed by the same phonetic algorithm used in step 104 to create phonetic codes. The phonetic codes associated with the text can then be compared to the phonetic codes generated from the contact list 26 (step 110). Matches between the phonetic codes are identified. Duplicate matches between a name from the text and more than one contact 28 are also identified. A list of matched names and contacts 28 including duplicates can be presented to the user 20 for confirmation (step 112). The user 20 can confirm that the matches are correct and resolve any duplicates, if necessary (step 114). According to one embodiment of the invention, the user 20 may also have the option to view or listen to a segment of the media item 22 at the location where the respective contact 28 was referenced. This may be particularly useful in the context of duplicates. The user 20 then sends a confirmation response to the identification module 50 (step 116). The media item 22 can then be tagged with the appropriate tag (step 118) and then the media item 22 can be published (step 120). A link to the media item 22 can be generated (step 122). The link can be sent to any individual that has been identified in the tags of the media item 22 via an email, for example.

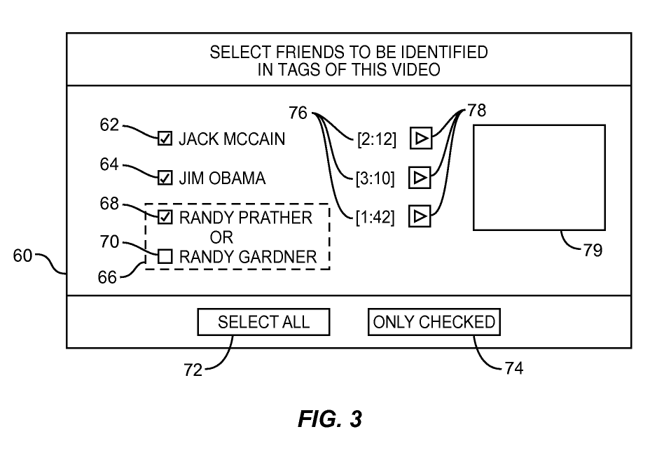

FIG. 3 is a dialogue box suitable for receiving confirmation from a user regarding identified tags according to another embodiment of the present invention. A dialogue box 60 can be presented to the user, which includes information relating to the names or contacts identified in the media item. For example, contacts 62 and 64 were identified in the media item. The user has the option of indicating via a check box whether to tag the media item with these contacts 62 and 64. A duplicates box 66 is presented showing that the name ‘Randy’ referenced in the media item matched two contacts, specifically contacts 68 and 70. The user has the option of selecting one of the contacts 68 and 70 to clarify which of the contacts 68 and 70 the media item should be tagged with. Additional boxes may be presented to the user to simplify the process, including a ‘Select All’ box 72 enabling the user to select all of the identified contacts, or an ‘Only Checked’ box 74 indicating that only the boxes checked should be tagged to the media item. Time offset fields 76 can be presented to the user indicating when the respective contact was referenced in the media item. Preview fields 78 can also be presented to the user that, when activated, play a preview of the media item in a display field 79 at the relevant location in the media item where the contact was mentioned. Alternately, the duplicates box 66 may provide a slider bar containing clickable reference icons (not shown) associated with the identified contacts that, when selected by the user, preview the media item in the display field 79 at the relevant location where the respective contact was mentioned.

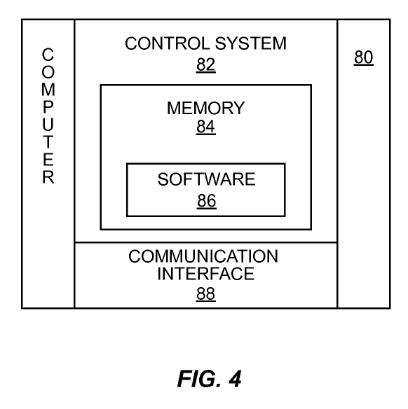

FIG. 4 is a block diagram of a computer 80 suitable for implementing aspects according to one embodiment of the present invention. The computer 80 includes a control system 82, which contains a memory 84 in which software 86 suitable for implementing the functionality described herein can reside. A communication interface 88 can be used to communicate with the network 14.

Those skilled in the art will recognize improvements and modifications to the preferred embodiments of the present invention. All such improvements and modifications are considered within the scope of the concepts disclosed herein and the claims that follow.

What is claimed is:

1. A method for automatically identifying a tag for a media item associated with a user comprising:
obtaining at least one contact associated with the user;
determining that a name referenced in an audio track matches the at least one contact; and
selecting one of the name and the at least one contact as the tag for the media item.

2. The method of claim 1 further comprising presenting the tag to the user for confirmation and tagging the media item with the tag if the user provides confirmation.

3. The method of claim 1 further comprising tagging the media item with the tag.

4. The method of claim 3 further comprising sending a link to the media item to a second user associated with the tag.

5. The method of claim 1 further comprising converting the audio track into a textual format.

6. The method of claim 5 wherein converting the audio track into the textual format comprises providing a list identifying a plurality of social contacts associated with the user, and resolving the audio track into the textual format based on the list, wherein the textual format includes only words identified in the list.

7. The method of claim 5 wherein the at least one contact is in the textual format.

8. The method of claim 1 further comprising:
converting the at least one contact into a first identifier code; and
converting the name into a second identifier code,
wherein determining that the name referenced in the audio track matches the at least one contact comprises determining that the first identifier code matches the second identifier code.

9. The method of claim 1 wherein the at least one contact comprises a plurality of contacts, and wherein determining that the name referenced in the audio track matches the at least one contact comprises determining that the name referenced in the audio track matches at least two of the plurality of contacts, further comprising:
presenting the at least two of the plurality of contacts to the user; and
receiving from the user a selection of one of the at least two of the plurality of contacts,
wherein selecting the one of the name and the at least one contact as the tag for the media item comprises selecting one of the name and the one of the at least two of the plurality of contacts as the tag.

10. The method of claim 1 wherein the media item comprises one of a video recording and an audio recording.

11. An apparatus comprising:
a receive module operative to receive at least one identifier and a media item associated with a user;
a determination module adapted to determine that a name referenced in an audio track associated with the media item matches the at least one identifier; and
a selection module adapted to select a tag as a function of the at least one identifier for the media item.

12. The apparatus of claim 11 further comprising a messaging module adapted to send a link to the media item to a second user associated with the at least one identifier.

13. The apparatus of claim 11 wherein the apparatus comprises a computer associated with the user.

14. The apparatus of claim 11 wherein the apparatus comprises a server adapted to communicate with a computer associated with the user.

15. The apparatus of claim 11 further comprising a presentation module adapted to present the tag to the user for confirmation and to tag the media item with the tag if the user provides confirmation.

16. The apparatus of claim 11 wherein the at least one identifier comprises a plurality of identifiers, and wherein the determination module is adapted to determine that the name matches at least two of the plurality of identifiers, the apparatus further comprising a presentation module adapted to:
present the at least two of the plurality of identifiers to the user; and
receive from the user a selection of one of the at least two of the plurality of identifiers,
wherein the selection module is further adapted to select the tag as a function of the one of the at least two of the plurality of identifiers as the tag.

17. The apparatus of claim 11 wherein the tag comprises a hypermedia object.

18. An apparatus providing a website comprising:
an interface adapted to communicate with a network; and
a control system adapted to:
receive a media item associated with a user;
compare a name referenced in an audio track to at least one identifier;
determine that the name matches the at least one identifier; and
select a tag as a function of the at least one identifier for the media item; and
a user interface adapted to receive a reference to the media item, wherein the apparatus obtains the media item via the reference.

19. The apparatus of claim 18 wherein the user is a first member of the website.

20. The apparatus of claim 19 wherein the at least one identifier is associated with a second member of the website, and wherein the apparatus further comprises a messaging module adapted to send a link to the media item to the second member.

21. The apparatus of claim 20 wherein the at least one identifier comprises a plurality of identifiers, and wherein to determine that the name matches the at least one identifier, the control system is further adapted to determine that the name matches at least two of the plurality of identifiers, and wherein the control system is further adapted to:
present the at least two of the plurality of identifiers to the user;
receive from the user a selection of one of the at least two of the plurality of identifiers; and
select the tag as a function of the one of the at least two of the plurality of identifiers.

22. The apparatus of claim 18 wherein the control system is further adapted to present the tag to the user for confirmation and to tag the media item with the tag if the user provides confirmation.

23. A method comprising:
extracting an audio track from video content;
converting speech in the audio track to text;
comparing the text to a plurality of contacts to identify an acquaintance associated with the video content; and
providing a tag identifying the acquaintance for the video content.
